(19) United States
(12) Patent Application Publication
(10) Pub. No.: US 2024/0309916 A1
(43) Pub. Date: Sep. 19, 2024

(54) DRIVE UNIT WITH COUPLING UNIT

(71) Applicant: Dr. Fritz Faulhaber GMbH & Co.KG, Schönaich (DE)

(72) Inventor: James Russell RITTER, III, Clearwater, FL (US)

(21) Appl. No.: 18/121,118

(22) Filed: Mar. 14, 2023

(51) Int. Cl. F16D 3/12

(52) U.S. Cl. CPC F16D 3/12; F16D 2300/22; F16H 2057/02034

(57) ABSTRACT

A drive unit comprising a motor, a drive shaft and a coupling unit. The coupling unit comprising a bearing sleeve, an input hub, an output hub and a torsion spring. The bearing sleeve at least partially surrounding said drive shaft and said torsion spring surrounding said bearing sleeve. The input hub coupled to said drive shaft and being at least partially rotatably mounted on said bearing sleeve. The input hub is at least partially arranged between the two spring ends, wherein the output hub is at least partially rotatably mounted on the bearing sleeve. The input hub acts on the torsion spring upon a rotation caused by the input hub and thereby slides on the bearing sleeve, and that upon rotation caused by the output hub, the output hub acts on the torsion spring in such a way that the torsion spring interacts with the bearing sleeve and prevents rotation.

### FIELD

The invention relates to a drive unit with at least one motor, at least one drive shaft and at least one coupling unit. The coupling unit is in particular connected to the drive shaft.

### BACKGROUND

Drive units with coupling units are known in the prior art in a variety of designs. Coupling units are used, for example, to couple the motor to loads or other drive components or to separate it from them. In a special embodiment, a coupling unit can also serve to brake an motor or prevent the drive shaft from rotating backwards. Furthermore, coupling units can serve to protect the motor from overload or damage due to sudden loads or vibrations by acting as a buffer zone between the motor and further drive components.

Known coupling units often have the disadvantage that they require actively controlled components for the actuation of the coupling unit, which increases the effort for the manufacturing and its costs.

The invention is therefore based on the object of specifying a drive unit for which the manufacturing effort is low and the manufacturing costs are reduced.

### SUMMARY

The aforementioned object is solved with a drive unit described and claimed in the claims. The drive unit comprises at least one motor, at least one drive shaft and at least one coupling unit. The coupling unit comprises at least one bearing sleeve, at least one input hub, at least one output hub and at least one torsion spring. The bearing sleeve is arranged to at least partially surround the drive shaft.

Depending on the embodiment of the drive unit, it is provided, for example, that the drive unit advantageously has at least one gearbox, and that the drive shaft surrounded by the bearing sleeve is an output shaft of the gearbox. For example, the bearing sleeve is then attached to a housing of the gearbox. The gearbox is connected to the motor shaft of the motor on a drive side and is drivable by the motor.

Alternatively, it is provided that the motor is directly connected to the coupling unit. In this case, the drive shaft is the motor shaft of the motor. The bearing sleeve is then directly connected to the housing of the motor.

The torsion spring has at least two spring ends. Preferably, the torsion spring has at least or exactly three, at least or exactly four, or at least or exactly five windings that completely surround the bearing sleeve. The torsion spring is arranged on the bearing sleeve in such a way that the windings surround the bearing sleeve and the windings can brace the torsion spring against the bearing sleeve, so that in particular no rotation of the torsion spring occurs on the bearing sleeve. In particular, the torsion spring is made of a spring steel.

The input hub is directly coupled to the drive shaft, i.e.—as explained above—an output shaft of the transmission or the motor shaft of the motor. For example, the input hub is substance-to-substance connected to the drive shaft, for example welded or bonded. The input hub is rotatably mounted on the bearing sleeve so that the input hub can rotate about the bearing sleeve relative to the bearing sleeve. The input hub is designed such that it extends at least partially between the two spring ends of the torsion spring.

For example, the two spring ends of the torsion spring are spaced apart. The spring ends are parallel to each other or open outward at an angle to each other. In any case, the input hub is at least partially arranged between the two spring ends, in particular so that the input hub overlaps the windings of the torsion spring. The output hub is also at least partially rotatably mounted on the bearing sleeve.

According to the invention, the two spring arms are arranged between the input hub and the output hub in such a way that the input hub acts on the torsion spring during a rotation caused by the input hub in such a way that the torsion spring increases its diameter, in particular the diameter of the windings, and can thus slide on the bearing sleeve. Consequently, when the input hub is moved, in particular rotated, by the drive shaft, movement of the input hub on the bearing sleeve is released by the torsion spring so that rotation of the output hub is also caused by the input hub. When the input hub is rotated, the coupling unit is coupled or a movement is released and torque is transmitted from the input hub to the output hub. The output hub has at least one output shaft. The output hub, in particular the output shaft, is connected to a load, for example.

If, on the other hand, the output hub is rotated, for example resulting from the output shaft by a load, without rotation of the input hub, the output hub acts on the torsion spring in such a way that the torsion spring interacts with the bearing sleeve, namely the windings are braced on the bearing sleeve, and rotation, in particular transmission of the rotation to the input sleeve, is prevented. As a result of the input hub being coupled to the torsion spring via the bearing sleeve, back rotation of the input hub via the output hub is prevented. A transmission of rotation from the input hub to the output hub can be bidirectional, i.e. in both directions of rotation.

The coupling unit consequently implements a passive, bidirectional brake, namely when the force of the input hub is no longer sufficient to expand the torsion spring or the motor is free from electric voltage, and at the same time a mechanism to prevent the drive shaft from rotating backwards. By mounting the input hub and the output hub on the bearing sleeve, radial and/or axial loading of the drive shaft is prevented.

Lash of the coupling unit is preferably minimized by the fact that, according to a further embodiment of the drive unit, a plurality of torsion springs are arranged on the bearing sleeve. Preferably, at least or exactly two or at least or exactly three torsion springs are arranged on the bearing sleeve. The torsion springs are arranged spaced apart from each other on the bearing sleeve. The spring ends of the two torsion springs preferably extend in the same directions, in particular the input hub is arranged between the two spring ends of the respective torsion springs. All spring ends of all torsion springs preferably extend, in particular in radial direction, between the input hub and the output hub. For example, the spring ends protrude from the bearing sleeve tangentially to the bearing sleeve.

Each of the torsion springs preferably has at least or exactly four windings surrounding the bearing sleeve. The use of at least four windings in the torsion springs ensures that, despite lubrication on the surface of the bearing sleeve, reliable tensioning of the respective torsion spring on the bearing sleeve is possible if rotation emanates from the output hub or the force emanating from the input hub is too low.

In particular, in order to further reduce lash in the coupling unit, according to a further embodiment it is provided that at least one slip torsion spring is arranged on the bearing sleeve. The slip torsion spring ends of the slip torsion spring are arranged in such a way that the diameter of the slip torsion spring is not increased during a rotation of the input hub, but the slip torsion spring is merely rotated with a certain tension on the bearing sleeve. The slip torsion spring ends are preferably in contact with the output hub with a slight preload, so that a constant tension is built up between the bearing sleeve and the output hub, reducing lash in the coupling unit. The slip torsion spring has at least or exactly two windings surrounding the bearing sleeve. The slip torsion spring preferably cotenses with the torsion spring or torsion springs when rotation originates from the output hub, and is moved against its tension on the bearing sleeve when rotation originates from the input hub.

In order to advantageously fasten the bearing sleeve, according to a further embodiment of the drive unit it is provided that the bearing sleeve has at least one flange, and that the bearing sleeve is fastened with the flange to a gearbox housing or to a housing of the motor. The flange is screwed to the gearbox housing or a housing of the motor, for example, by three screws running parallel to the longitudinal axis of the bearing sleeve.

Preferably, the bearing sleeve is formed integrally with the flange. Advantageously, the flange has at least one interface, for example a bayonet lock, a thread or an interrupted thread, in order to be connected to a coupling housing. Furthermore, it is advantageously provided that at least one bearing surface for a first bearing is provided on the bearing sleeve.

The flange gives the bearing sleeve the necessary stability to extend from the gearbox housing or the housing of the motor and to prevent a radial and/or axial load on the drive shaft. It is provided that the input hub and the output hub are exclusively supported at least indirectly on the bearing sleeve and the flange, so that the drive shaft is protected from axial and radial loads.

Particularly preferably, according to a further embodiment of the drive unit, at least one coupling housing is provided, and the coupling housing is attached to the flange of the bearing sleeve. Preferably, the coupling housing surrounds the input hub and the output hub so that only an output shaft of the output hub protrudes from the coupling housing. Consequently, the flange and the coupling housing are fixed relative to the gearbox housing or relative to the housing of the motor. Preferably, the coupling housing is releasably secured to the flange of the bearing sleeve. For example, it is provided that a bayonet lock or a thread is formed between the flange and the coupling housing. The bayonet lock preferably has at least three segments with which the coupling housing can or does interact in a form-fitting manner.

In the design of the input hub, it has been found advantageous if, according to a further embodiment, it is provided that a first input hub portion of the input hub extends at least partially in the bearing sleeve, and that the first input hub portion is connected to the drive shaft. The drive shaft is surrounded by the bearing sleeve. In order for the input hub to be connected to the drive shaft, the input hub extends into the bearing sleeve. Preferably, the first input hub portion extends along the entire length of the bearing sleeve. For example, the first input hub portion is substance-to-substance connected to the drive shaft, for example glued or welded.

A further embodiment of the drive unit provides that a second input hub portion of the input hub at least partially surrounds the bearing sleeve, and that the input hub is mounted with the second input hub portion on the bearing sleeve. The second input hub portion is connected to the first input hub portion, preferably integrally. The bearing sleeve ends in particular inside the input hub, so that the input hub overlaps the bearing sleeve at the end. At least the second input hub portion extends on the outside of the bearing sleeve likewise almost over the entire length of the bearing sleeve. The second input hub portion preferably overlaps the windings of the torsion spring or torsion springs on the bearing sleeve. At the drive shaft end of the bearing sleeve, the input hub, in particular the second input hub portion, is rotatably mounted on the bearing sleeve.

According to a further embodiment, it has turned out to be advantageous if the input hub, in particular with the second input hub portion, is mounted on the bearing sleeve with a first bearing. The first bearing is preferably designed as a ball bearing. The first bearing is arranged on an outer circumference of the bearing sleeve. Further, the input hub is supported by a second bearing within the output hub. Preferably, the input hub has a bearing web on an end side facing away from the drive shaft, which can be inserted into a bearing, in particular a ball bearing. The bearing is advantageously mounted in the output hub. The fact that the input hub is mounted independently of the drive shaft means that the drive shaft can be kept free of radial and axial loads.

Furthermore, it has been found to be advantageous if the output hub is designed in such a way that the output hub at least partially surrounds the input hub in a sleeve-like manner. The output hub has at least one recess. This recess of the output hub extends, for example, in the longitudinal direction of the output hub. In the assembled state, the input hub, in particular the second input hub portion, and the torsion spring ends extend at least partially in the recess. For example, the second input hub portion is dimensioned to be approximately on the same circumference as the outer circumference of the output hub. In particular, the second input hub portion at least partially fills the recess.

The second input hub portion preferably fills the recess in such a way that. viewed in the longitudinal direction, a gap is formed on the left and right of the second input hub portion respectively between the input hub and the output hub, in which the torsion springs are arranged or in which the torsion springs are guided outwards. The gaps between the input hub and the output hub are dimensioned such that the spring ends of the torsion springs are arranged at a distance from both the input hub and the output hub. In particular, the width of the gaps is greater than the diameter of the material of the torsion spring or springs. This is necessary to allow the torsion spring or torsion springs to deform, in particular to release a movement on the bearing sleeve.

For example, the input hub has two flat side flanks. In particular, the side flanks of the input hub, especially of the second input hub portion, are designed to taper away from the longitudinal axis towards each other, so that an advantageous interaction with the spring ends can take place during a rotation. The torsion springs or the torsion spring is arranged on the bearing sleeve in such a way that a first torsion spring end of a spring extends in a first gap and a second torsion spring end extends in an oppositely arranged, second gap or is guided outwards through the respective gap.

In order to protect the drive shaft advantageously against axial and radial loads, according to a further embodiment it is provided that the output hub has at least one second bearing recess for receiving a second bearing for supporting the input hub. The bearing recess is preferably formed at the end of the output hub facing away from the drive shaft in an end flange of the output hub. Furthermore, at the end facing the drive shaft, the output hub has a second bearing recess for at least partially receiving the first bearing. The first bearing is supported on the bearing sleeve that also supports the second input hub portion. It is provided that the first bearing supports the output hub, in particular the sleeve-like output hub, over part of its circumference and, where the recess is formed in the sleeve-like output hub, the second input hub portion is supported on the first bearing.

In particular for further reduction of lash in the coupling unit, according to a further embodiment it has proved advantageous if the output sleeve has at least one sealing element on at least one end face, and that the sealing element is arranged between the output sleeve and a coupling housing. The sealing element is preferably designed as an O-ring and in particular represents a buffer between the end face of the output hub, for example an end face flange of the output hub, and an inner surface of a coupling housing.

For example, the output hub has an output shaft that passes through the coupling housing and to which a load can be coupled. For example, the output hub is supported by the output shaft in the third bearing, in particular ball bearing, in the coupling housing. As described above, the coupling housing is preferably supported on a flange of the bearing sleeve and thus on the transmission housing or the housing of the motor.

In particular, the transmission of forces via the spring ends of the torsion springs to the output hub and vice versa is preferable according to one embodiment of the drive unit that at least one spring end at least partially surrounds the output hub on an outer circumference. For this purpose, the torsion spring or the spring end has a rounded shape that essentially corresponds to the outer contour of the output hub. For example, the spring end surrounds the output hub on at least a quarter, in particular at least half, of the outer circumference of the output hub. This embodiment shifts the bending of the torsion spring under a load to a region outside the axis of rotation, thereby increasing the load capacity of the torsion spring.

By redirecting the force, the load on the spring is converted from a bending moment to a tensile load, which can increase the braking force of the spring. Friction of the spring on the outer circumference of the output hub causes friction before bending of the spring, which further increases the load capacity of the spring.

It has been found to be particularly advantageous if both torsion spring ends of the torsion spring at least partially surround the output hub on an outer circumference. Preferably, the two torsion spring ends of the torsion spring are bent in such a way that the two torsion spring ends surround the output hub in opposite directions on the outer circumference. Preferably, both torsion spring ends surround the output hub by at least a quarter, in particular at least half, of the circumference of the output hub.

Preferably in order to improve the transmission of force from the torsion spring to the output hub, according to a further embodiment it has been found to be advantageous if it is provided that the output hub has at least one groove on an outer circumference for at least one spring end of a torsion spring. Preferably, the groove is formed circumferentially and serves to guide the spring end. Preferably, it is provided that one groove for each spring end is formed on the outer circumference of the output hub. The grooves are spaced apart from one another. Preferably, a radius is formed when the spring ends are deflected from the inner circumference to the outer circumference of the output hub.

In the embodiment in which at least one spring end, preferably all spring ends, at least partially surround the output hub on an outer circumference, it is provided that at least one groove is formed for each spring end on the outer circumference of the output hub. In a variant with two torsion springs, the output hub has in particular at least or exactly four grooves on the outer circumference.

The invention further relates to a coupling unit, in particular for a drive unit described, comprising at least one bearing sleeve, at least one input hub, at least one output hub and at least one torsion spring. The further embodiments of the coupling unit result from the described embodiments.

Whenever statements are made above or below concerning the design of a feature or component in the singular, these statements refer to each of these components or features-if there are a plurality of these components or features, unless otherwise indicated.

### BRIEF DESCRIPTION OF THE DRAWINGS

Further advantageous embodiments of the invention are apparent from the following description of figures and the dependent claims when taken in conjunction with the accompanying drawings wherein:

FIG. 1 is an embodiment of a drive unit in perspective exploded view,

FIG. 2 is a sectional view of the embodiment of the drive unit according to FIG. 1,

FIG. 3 is an embodiment of a part of a drive unit in perspective view,

FIG. 4 is a section through the embodiment according to FIG. 2,

FIG. 5 is a section through the embodiment according to FIG. 6,

FIG. 6 is a part of a second embodiment of a drive unit in perspective view,

FIG. 7 is the embodiment according to FIG. 6 without output hub in perspective view,

FIG. 8 is a torsion spring for the embodiment of FIGS. 6 and 7, and

FIG. 9 is an output hub of the embodiment of FIGS. 6 and 7.

### DETAILED DESCRIPTION

In the various figures in the drawing, the same parts are always given the same reference signs.

Regarding the following description, it is claimed that the invention is not limited to the embodiments and thereby not limited to all or several features of described feature combinations, rather each individual partial feature of the/each embodiment is also of importance for the subject matter of the invention detached from all other partial features described in connection therewith for itself and also in combination with any features of another embodiment.

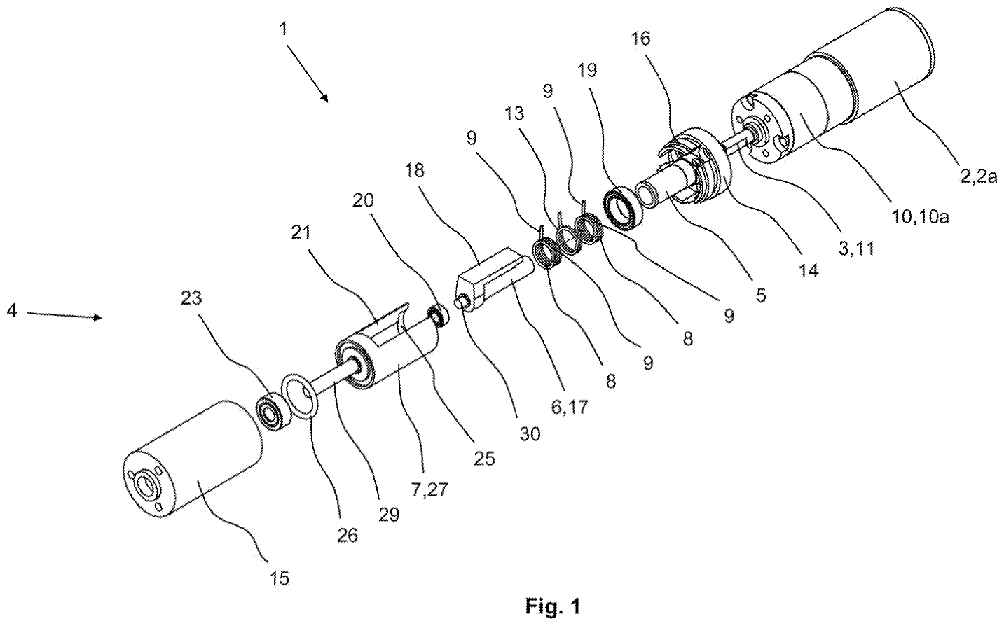

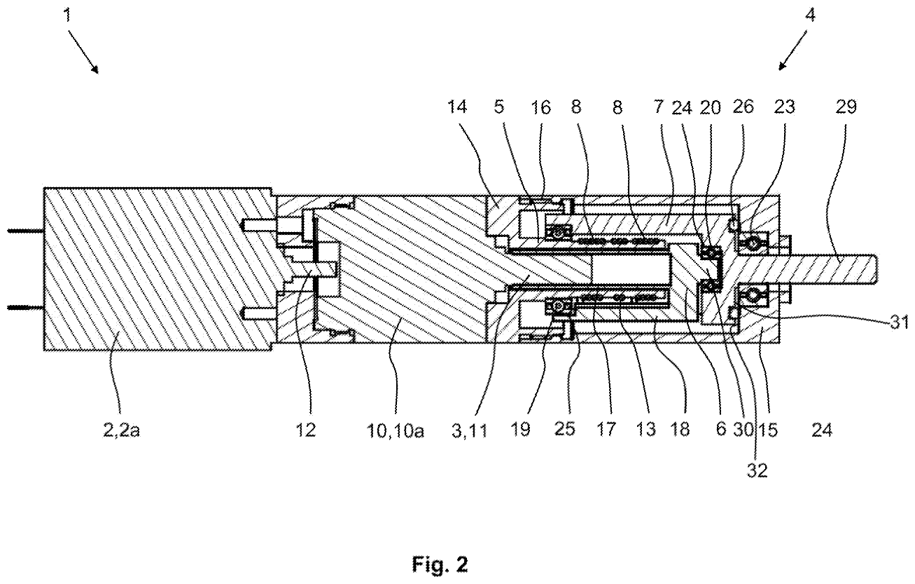

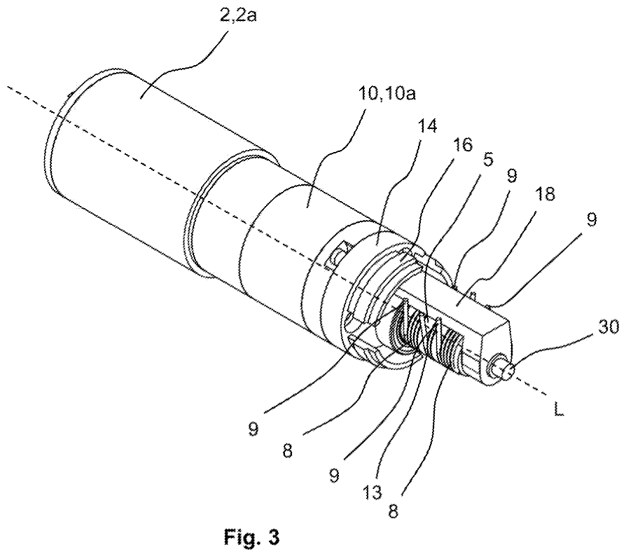

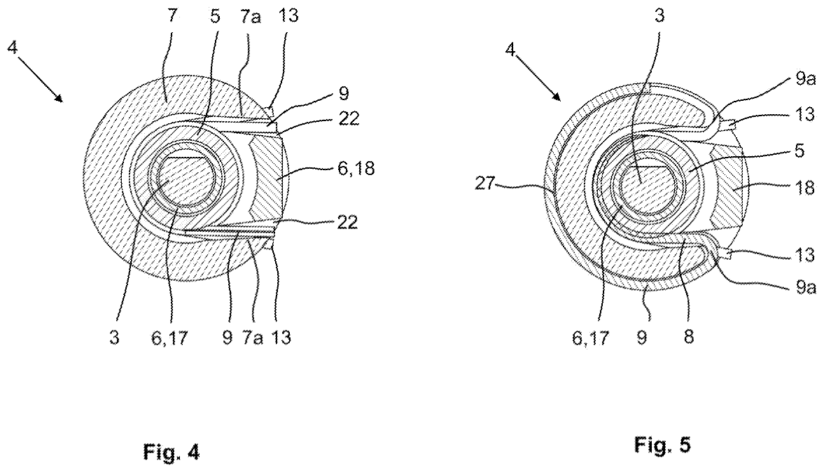

FIGS. 1 to 4 show a first embodiment of a drive unit 1. FIG. 1 shows the embodiment in a perspective exploded view, FIG. 2 in a sectional view, FIG. 3 in a partial representation in perspective view and FIG. 4 a sectional view through a coupling unit 4. The drive unit 1 has at least one motor 2, at least one drive shaft 3 and at least one coupling unit 4. The motor 2 and a gearbox 10 are shown in section in FIG. 2 only schematically and without details. The coupling unit 4 has at least one bearing sleeve 5, at least one input hub 6, at least one output hub 7 and, in this embodiment, two torsion springs 8.

The bearing sleeve 5 is arranged to surround the drive shaft 3. The torsion springs 8 are arranged at a distance from each other on the bearing sleeve 5, so that the spring ends 9 of the torsion springs 8 project essentially tangentially from the bearing sleeve 5. The input hub 6 is coupled to the drive shaft 3, bonded in the present embodiment. The input hub 6 is rotatably mounted on the bearing sleeve 5. The input hub 6 is designed in such a way that it extends between the spring ends 9 of the two torsion springs 8. As a result, the spring arms 9 of the torsion springs 8 are arranged between the input hub 6 and the output hub 7 in such a way that, when rotation is caused by the input hub 6, the input hub 6 acts on the torsion springs 8 in such a way that the torsion springs 8 increase their diameter and can thereby slide and rotate on the bearing sleeve 5. As a result, the rotation of the input hub 6 is transmitted to the output hub 7 so that the rotation can be picked up at an output shaft 29 of the output hub 7.

However, when rotation is caused starting from the output hub 7, i.e. the output shaft 29, the output hub 7 acts on the torsion springs 8 in such a way that the torsion springs 8 interact with the bearing sleeve 5, namely brace on the bearing sleeve 5, preventing rotation and thus a load on the drive shaft 3. Furthermore, the input hub 6 is braked by the torsion springs 8 when the motor 2 is de-energized.

In this embodiment, the drive unit 1 has at least one gearbox 10 and the drive shaft 3 is an output shaft 11 of the gearbox 10. The motor shaft 12 of the motor 2 drives the gearbox 10. A slip torsion spring 13 is arranged on the bearing sleeve 5 between the torsion springs 8. The torsion springs 8 have four windings surrounding the bearing sleeve 5. The slip torsion spring 13 has only two windings surrounding the bearing sleeve 5. The slip torsion spring 13 serves to reduce lash of the coupling unit 4, which is why the slip torsion spring 13 braces on the bearing sleeve 5 unchanged when the input hub 6 or the output hub 7 moves. The slip torsion spring 13 slips on the bearing sleeve 5 when the input hub 6 rotates, which always applies tension to the output hub 7 and reduces lash in the coupling unit 4.

The bearing sleeve 5 has at least one flange 14, by means of which the bearing sleeve 5 is fastened at the end face to a gearbox housing 10a. In this embodiment, the flange 14 is screwed to the gearbox housing 10a with three screws. The coupling unit 4 is surrounded by a coupling housing 15, which is connected to the flange 14 of the bearing sleeve 5 or fastened to the flange 14. For this purpose, the flange 14 has a three-part thread 16 to which the coupling housing 15 can be connected in a form-fitting manner.

According to FIGS. 1 to 3, the input hub 6 has a first input hub portion 17 which extends over the entire longitudinal extent of the bearing sleeve 5 within the bearing sleeve 5 and is connected to the drive shaft 3 in a form-fitting and substance-to-substance bond manner. A second input hub portion 18 of the input hub 6 extends at the end face and on the outer circumference of the bearing sleeve 5. The second input hub portion 18 is of substantially web-like shape and extends parallel to the longitudinal axis L of the coupling unit 4. The second input hub portion 18 serves both to actuate the torsion springs 8, in particular the spring ends 9, and to mount the input hub 6 on the bearing sleeve 5 with a first bearing 19. The bearing 19 is designed as a ball bearing and is held on the bearing sleeve 5. Furthermore, the input hub 6 is supported by a second bearing 20 in the output hub 7. For this purpose, the input hub 6 has a bearing web 30 which extends on the end face and is inserted into the second bearing 20, which is also designed as a ball bearing.

The output hub 7 is of sleeve-like design and at least partially surrounds the input hub 6. The output hub 7 has a recess 21 which extends along the longitudinal extent of the output hub 7. The input hub 6, in particular the second input hub portion 18, is arranged in the recess 21 and extends substantially on the same outer circumference.

FIG. 4 shows a section through the embodiment of FIGS. 1 and 2 in the area of a torsion spring 8 or the coupling unit 4. Two oppositely arranged gaps 22 are formed between the input hub 6 and the output hub 7, in particular between the second input hub portion 18 of the input hub 6 and the output hub 7. In the gaps 22, the torsion spring ends 9 extend or protrude from the output hub 7 through the gaps 22. A width of the gaps 22 is larger than the diameter of the material of the torsion springs 8, so that the spring ends 9 can move slightly in the gaps 22. At the second input hub portion 18, the input hub 6 has two flat side flanks 18a inclined towards each other for easier interaction with the torsion spring ends 9. Two opposite inner flanks 7a of the output hub 7 are substantially parallel to each other or are inclined towards each other with increasing radial distance from the drive shaft 3. The side flanks 18a are inclined more towards each other than the inner flanks 7a.

When the input hub 6 is rotated by the drive shaft 3 in any direction, the second input hub portion 18 causes the respective spring end 9 in the gap 22 to move in the direction of the output hub 7. This increases the diameter of the torsion spring 8, allowing it to slide or rotate on the lubricated bearing sleeve 5. Consequently, the rotational movement originating from the input hub 6 is transmitted to the output hub 7 so that the coupling unit 4 can rotate freely and the rotation of the input hub is transmitted to the output shaft 29.

If a rotational movement is caused in any direction starting from the output hub 7 to the spring ends 9, these are merely pressed against the input hub 6. Since there is no expansion of the diameter of the windings of the torsion springs 8. they continue to be braced on the bearing sleeve 5 and thus prevent rotation of the input hub 6. This reliably prevents reverse rotation of the coupling unit 4 and thus a torsional load on the drive shaft 3. The torsion springs 8 further brake the input hub 6 if sufficient force is no longer applied by the input hub 6 to the spring ends 9.

According to FIG. 2, the output hub 7 is also supported on the first bearing 19 on the bearing sleeve 5. For this purpose, the output hub 7 has a second bearing recess 25. The output hub 7 is further supported by a third bearing 23 in the coupling housing 15. In particular, the output shaft 29 interacts with the third bearing 23 and is supported in the third bearing 23. As a result of the input hub 6 and the output hub 7 being supported only on the bearing sleeve 5 and the coupling housing 15, respectively, the drive shaft 3 is completely freed from radial or axial load, while at the same time ensuring that no reverse rotation of the coupling unit 4 can occur via the output hub 7. The second input hub portion 18, which extends in the recess 21 of the output hub 7, is also mounted on the first bearing 19 on the bearing sleeve 5.

In particular, in order to minimize axial lash in the coupling unit 4, a sealing element 26 in the form of an O-ring is arranged between a face flange 31 of the output hub 7 and an inner surface 32 of the coupling housing 15.

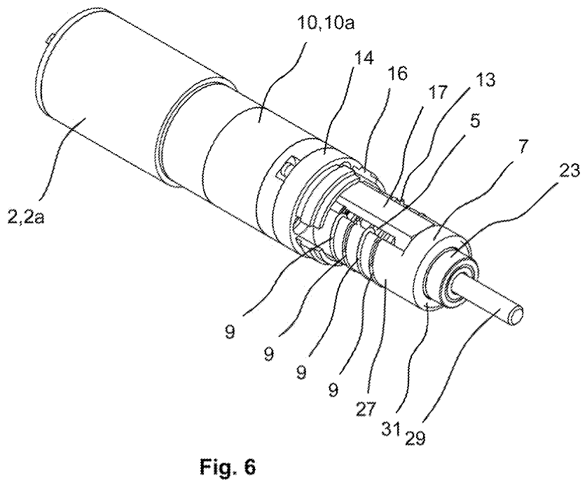

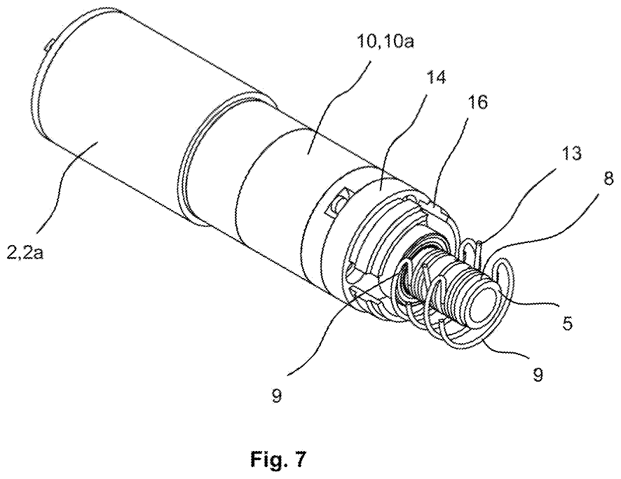

FIGS. 5, 6 and 7 show an alternative embodiment of a drive unit 1. FIG. 5 shows the embodiment in a sectional view in the area of a torsion spring 8 in the coupling unit 4, FIG. 6 shows part of the embodiment in perspective view, FIG. 7 shows a further part of the embodiment also in perspective view. The second embodiment is functionally designed essentially as the embodiment described above, so that reference is made to the description thereof.

In the second embodiment, the spring ends 9 are significantly longer and are bent with a radius in a transition region 9a in such a way that they extend over an outer circumference 27 of the output hub 7. Since the torsion springs 8 are subjected to tensile loading in the area of the spring ends 9 when loaded as a result, significantly higher braking forces can be applied. The slip torsion spring 13 does not have extended torsion spring ends 9, so that its slip torsion spring ends continue to protrude tangentially from the bearing sleeve 5.

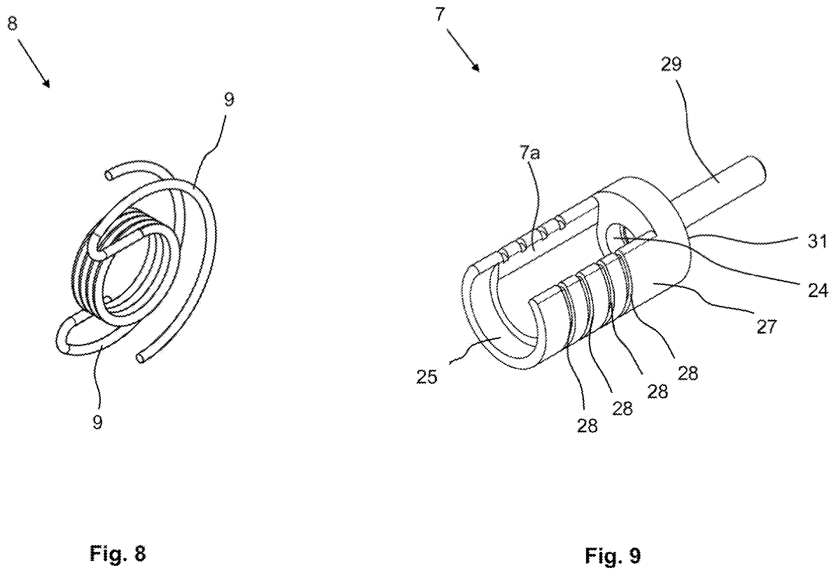

Both torsion spring ends 9 of a torsion spring 8 surround the outer circumference 27 of the output hub 7 in opposite directions and extend over at least about half of the outer circumference 27. In particular to ensure guidance of the torsion springs 8, the output hub 7 has four grooves 28—see also FIG. 9—on the outer circumference 27 in which the torsion spring ends 9 are guided and can move. An example of such a torsion spring 8 with the bent spring ends 9 extending over the outer circumference 27 is shown in FIG. 8. The spring ends 9 extending from the windings of the torsion spring 8 are bent in opposite directions and have a larger radius than the windings so that they can extend on the outer circumference 27 of an output hub 7.

FIG. 9 shows the embodiment of an output hub 7 in perspective view. The grooves 28 extend on the outer circumference 27 into the inner flanks 7a. The transition area from the outer circumference 27 to the inner flanks 7a has a radius to prevent excessive loading in the transition areas 9a—see FIG. 5—of the torsion springs 8.

### Aspects of the Invention:

1. Drive unit (1), comprising at least one motor (2), at least one drive shaft (3) and at least one coupling unit (4), wherein the coupling unit comprises at least one bearing sleeve (5), at least one input hub (6), at least one output hub (7) and at least one torsion spring (8), wherein the bearing sleeve (5) at least partially surrounds the drive shaft (3), wherein the torsion spring (8) has at least two spring ends (9), wherein the torsion spring (8) surrounds the bearing sleeve (5) with windings, wherein the input hub (6) is coupled to the drive shaft (3), wherein the input hub (6) is at least partially rotatably mounted on the bearing sleeve (5), wherein the input hub (6) is at least partially arranged between the two spring ends (9), wherein the output hub (7) is at least partially rotatably mounted on the bearing sleeve (5), wherein the spring ends (9) are arranged between the input hub (6) and the output hub (7) in such a way that the input hub (6) acts on the torsion spring (8) upon a rotation caused by the input hub (6) in such a way that the torsion spring (8) increases its diameter and thereby slides on the bearing sleeve (5), and that upon a rotation caused by the output hub (7), the output hub (7) acts on the torsion spring (8) in such a way that the torsion spring (8) interacts with the bearing sleeve (5) and prevents rotation,

2. Drive unit (1) according to aspect 1, characterized in that the drive unit (1) comprises at least one gearbox (10), and that the drive shaft (3) is the output shaft (11) of the gearbox (10), or that the drive shaft (3) is the motor shaft (12) of the motor (2).

3. Drive unit (1) according to aspect 1 or 2, characterized in that a plurality of torsion springs (8) are arranged on the bearing sleeve (5).

4. Drive unit (1) according to any of aspects 1 to 3, characterized in that at least one slip torsion spring (13) is arranged on the bearing sleeve (5) to reduce lash.

5. Drive unit (1) according to any one of aspects 1 to 4, characterized in that the bearing sleeve (5) has at least one flange (14), and in that the bearing sleeve (5) is attached by the flange (14) to a gearbox housing (10a) or to a housing (2a) of the motor (2).

6. Drive unit (1) according to aspect 5, characterized in that at least one coupling housing (15) is provided, and that the coupling housing (15) is attached to the flange (14) of the bearing sleeve (5).

7. Drive unit (1) according to any one of aspects 1 to 6, characterized in that a thread (16) or a bayonet lock is formed between the flange (14) and the coupling housing (15).

8. Drive unit (1) according to any one of aspects 1 to 7, characterized in that a first input hub portion (17) of the input hub (6) extends at least partially in the bearing sleeve (5), and in that the first input hub portion (17) is connected to the drive shaft (3).

9. Drive unit (1) according to any one of aspects 1 to 8, characterized in that a second input hub portion (18) of the input hub (6) at least partially surrounds the bearing sleeve (5), and in that the input hub (6) is mounted on the bearing sleeve (5) with the second input hub portion (18).

10. Drive unit (1) according to aspect 9, characterized in that the second input hub portion (18) is web-like and extends substantially parallel to a longitudinal axis (L) of the input hub (6).

11. Drive unit (1) according to any one of aspects 1 to 10, characterized in that the input hub (6) is supported by a first bearing (19) on the bearing sleeve (5) and a second bearing (20) in the output hub (7).

12. Drive unit (1) according to any one of aspects 1 to 11, characterized in that the output hub (7) at least partially surrounds the input hub (6) in a sleeve-like manner, and in that the output hub (7) has at least one recess (21), and in that the input hub (6) and the spring ends (9) extend at least partially within the recess (21).

13. Drive unit (1) according to aspect 12, characterized in that at least two gaps (22) are formed between the input hub (6) and the output hub (7), and in that one spring end (9) of the torsion spring (8) extends in each gap (22).

14. Drive unit (1) according to any one of aspects 1 to 13, characterized in that the output hub (7) is supported by a first bearing (19) on the bearing sleeve (5) and by a third bearing (23) in a coupling housing (15).

15. Drive unit (1) according to any one of aspects 1 to 14, characterized in that the output hub (7) has at least one first bearing recess (24) for receiving a second bearing (20) for supporting the input hub (6) and at least one second bearing recess (25) for receiving a first bearing (19).

16. Drive unit (1) according to any one of aspects 1 to 15, characterized in that the output sleeve (7) has at least one sealing element (26) on at least one end face, and in that the sealing element (26) is arranged between the output sleeve (7) and a coupling housing (15).

17. Drive unit (1) according to any one of aspects 1 to 16, characterized in that at least one spring end (9) of the torsion spring (8) at least partially surrounds the output hub (7) on an outer circumference (27) or that both spring ends (9) of the torsion spring (8) at least partially surround the output hub (7) on an outer circumference.

18. Drive unit (1) according to aspect 17, characterized in that the output hub (7) has at least one groove (28) for at least one spring end (9) on an outer circumference.

19. Coupling unit (4), in particular for a drive unit (1) according to one of aspects 1 to 18, wherein the coupling unit comprises at least one bearing sleeve (5), at least one input hub (6), at least one output hub (7) and at least one torsion spring (8),
wherein the torsion spring (8) has at least two spring ends (9), wherein the torsion spring (8) surrounds the bearing sleeve (5), wherein the input hub (6) is at least partially rotatably mounted on the bearing sleeve (5), wherein the input hub (6) is at least partially arranged between the two spring ends (9), wherein the output hub (7) is at least partially rotatably mounted on the bearing sleeve (5), wherein the spring ends (9) are arranged between the input hub (6) and the output hub (7) in such a way that the input hub (6) acts on the torsion spring (8) upon a rotation caused by the input hub (6) in such a way that the torsion spring (8) increases its diameter and thereby slides on the bearing sleeve (5), and that upon a rotation caused by the output hub (7), the output hub (7) acts on the torsion spring (8) in such a way that the torsion spring (8) interacts with the bearing sleeve (5) and prevents rotation.

The invention is not limited to the embodiments shown and described, but also includes all embodiments having the same effect in the sense of the invention. It is expressly emphasized that the embodiments are not limited to all features in combination, rather each individual sub-feature may also have inventive significance in isolation from all other sub-features. Furthermore, the invention has not yet been limited to the combination of features defined in claim 1 either, but can also be defined by any other combination of certain features of all the individual features disclosed as a whole. This means that in principle virtually any individual feature of claim 1 can be omitted or replaced by at least one individual feature disclosed elsewhere in the application.

### LIST OF REFERENCE SIGNS

1 Drive unit

2 Motor

3 Drive shaft

4 Coupling unit

5 Bearing sleeve

6 Input hub

7 Output hub

7a Inner flanks

8 Torsion spring

9 Spring end

9a Transition area

10 Gearbox

10a Gearbox housing

11 Drive shaft

12 Motor shaft

13 Slip torsion spring

14 Flange

15 Coupling housing

16 Thread

17 First input hub portion

18 Second input hub portion

18a Side Flank

19 First bearing

20 Second bearing

21 Recess

22 Gap

23 Third bearing

24 First bearing recess

25 Second bearing recess

26 Sealing element

27 Outer circumference

28 Groove

29 Output shaft

30 Bearing web

31 Flange

32 Inner surface of coupling housing 15

L Longitudinal axis

1. A drive unit comprising at least one motor, at least one drive shaft and at least one coupling unit, said coupling unit comprising at least one bearing sleeve, at least one input hub, at least one output hub and at least one torsion spring, wherein the bearing sleeve at least partially surrounds the drive shaft, wherein the torsion spring has at least two spring ends, wherein the torsion spring surrounds the bearing sleeve with windings, wherein the input hub is coupled to the drive shaft, wherein input hub is at least partially rotatably mounted on the bearing sleeve, wherein the input hub is at least partially arranged between the two spring ends, wherein the output hub is at least partially rotatably mounted on the bearing sleeve, wherein the spring ends are arranged between the input hub and the output hub in such a way that the input hub acts on the torsion spring upon a rotation caused by the input hub in such a way that the torsion spring increases its diameter and thereby slides on the bearing sleeve, and that upon rotation caused by the output hub, the output hub acts on the torsion spring in such a way that the torsion spring interacts with the bearing sleeve and prevents rotation.

2. The drive unit of claim 1, wherein the drive unit comprises at least one gearbox, and that the drive shaft is the output shaft of the gearbox, or that the drive shaft is the motor shaft of the motor.

3. The drive unit according to claim 1, wherein a plurality of torsion springs are arranged on the bearing sleeve.

4. The drive unit according to claim 1, wherein at least one slip torsion spring is arranged on the bearing sleeve to reduce lash.

5. The drive unit according to claim 1, wherein the bearing sleeve comprises at least one flange, and in that the bearing sleeve is attached by the flange to a gearbox housing or to a housing of the motor.

6. The drive unit of claim 5, wherein at least one coupling housing is provided, and that the coupling housing is attached to the flange of the bearing sleeve.

7. The drive unit according to claim 6, wherein a thread or a bayonet lock is formed between the flange and the coupling housing.

8. The drive unit according to claim 1, wherein a first input hub portion of the input hub extends at least partially within the bearing sleeve, and that the first input hub portion is connected to the drive shaft.

9. The drive unit according to claim 1, wherein a second input hub portion of the input hub at least partially surrounds the bearing sleeve, and that the input hub is mounted on the bearing sleeve with the second input hub portion.

10. The drive unit according to claim 9, wherein the second input hub portion is web-like and extends substantially parallel to a longitudinal axis of the input hub.

11. The drive unit according to claim 1, wherein the input hub is supported by a first bearing on the bearing sleeve and a second bearing in the output hub.

12. The drive unit according to claim 1, wherein the output hub at least partially surrounds the input hub in a sleeve-like manner, and in that the output hub includes at least one recess, and in that the input hub and the spring ends extend at least partially within the recess.

13. The drive unit according to claim 12, wherein at least two gaps are formed between the input hub and the output hub, and that one spring end of the torsion spring extends in each gap.

14. The drive unit according to claim 1, wherein the output hub is supported by a first bearing on the bearing sleeve and by a third bearing in a coupling housing.

15. The drive unit according to claim 1, wherein the output hub has at least one first bearing recess for receiving a second bearing for supporting the input hub and at least one second bearing recess for receiving a first bearing.

16. The drive unit according to claim 1, wherein the output sleeve has at least one sealing element on at least one end face, and in that the sealing element is arranged between the output sleeve and a coupling housing.

17. The drive unit according to claim 1, wherein at least one spring end of the torsion spring at least partially surrounds the output hub on an outer circumference or that both spring ends of the torsion spring at least partially surround the output hub on an outer circumference.

18. The drive unit according to claim 17, wherein the output hub has at least one groove on an outer circumference for at least one spring end.

19. A coupling unit comprising at least one bearing sleeve, at least one input hub, at least one output hub and at least one torsion spring, wherein the torsion spring has at least two spring ends, wherein the torsion spring surrounds the bearing sleeve, wherein the input hub is at least partially rotatably mounted on the bearing sleeve, wherein the input hub is at least partially arranged between the two spring ends, wherein the output hub is at least partially rotatably mounted on the bearing sleeve, wherein the spring ends are arranged between the input hub and the output hub in such a way that the input hub acts on the torsion spring upon a rotation caused by the input hub in such a way that the torsion spring increases its diameter and thereby slides on the bearing sleeve, and that upon a rotation caused by the output hub, the output hub acts on the torsion spring in such a way that the torsion spring interacts with the bearing sleeve and prevents rotation.
